(19) United States
(12) Patent Application Publication
(10) Pub. No.: US 2020/0401277 A1
(43) Pub. Date: Dec. 24, 2020

(54) PHONE OPERATING SYSTEM WITH SPLIT SCREEN

(71) Applicant: CLOUDBANTER LTD, London (GB)

(72) Inventors: Graham Williams, London (GB); Clay Babcock, Golden Valley, MN (US)

(73) Assignee: CLOUDBANTER LTD, London (GB)

(21) Appl. No.: 16/975,104

(22) PCT Filed: Feb. 23, 2018
(86) PCT No.: PCT/GB2018/050478

§ 371 Date: Aug. 21, 2020

(51) Int. Cl. G06F 3/0481; H04M 1/725; G06F 3/0488

(52) U.S. Cl. CPC G06F 3/0481; G06F 2203/04803; G06F 3/04886; H04M 1/72519

(57) ABSTRACT

A method for displaying windows on a screen of a mobile device comprising: providing, from a surface manager to a first window manager, a first window of a device wherein the first window is smaller than the area of the screen; generating, by the window manager, a first display for the first window; generating, by a dedicated content manager, a second display for a second window; wherein the second window is a portion of the screen not used by the first window manager, and wherein the second window is dedicated for use by the dedicated content manager; displaying, the first display in a first window and the second display in the second window.

This International Application claims priority from a PCT patent application having Patent Application No. PCT/GB2018/050478, filed on Feb. 23, 2018 and titled “PHONE OPERATING SYSTEM WITH SPLIT SCREEN”.

### FIELD

This invention relates to a method, device, and a computer program product for providing a second window on a screen of a device.

### BACKGROUND

international patent application publication No, WO 2016/063005 A1 describes a method for sending information to a user device over a wireless network using messages such as Short Message Service (SMS) messages that have a maximum size. A first part of a message is filled with primary information (a primary message) and a second part is at least partially filling with secondary information (e.g. news, stock prices, weather, advertisements). In this way, secondary information is “piggy-backed” onto other messages. The secondary information can be real-time in the sense that it can be updated in the course of a day, provided only that the user is receiving SMS messages (which is indicative of the device being in active use). Alternatively, the secondary information may be downloaded to the device in an off-peak time (e.g. overnight) and during the day, indicators may be received, piggy-backed onto other messages, causing the pre-stored information to be displayed and thereby giving the appearance that the secondary information is refreshed (the refreshing being under the control of a manager in the network). In each case, the secondary information is “real-time” in the sense that It is updated from time to time {regularly or periodically, but independent of the user) and in each case it is received from a network entity (e.g. a news server or an advertisement server) and that entity can be separate from the server that delivers the primary messages.

In that patent application, a messaging application is described that provides a display having a primary information window for displaying messages and a dedicated secondary information window for displaying the received (real time) secondary information. Such an arrangement has many benefits, but is dependent on the user launching the particular messaging application that has the secondary window for displaying the real time information. If a user is using other applications or uses a different messaging application, the user will not see the real time information.

US 2013/0139105 A1 is an example of a supplementary window manager being associated with a user-invoked supplementary window. The supplementary window is connected to the main window to provide a three-dimensional visual effect.

It is known for an operating system to set aside a small portion of a display to provide for a status bar with icons showing, for example, battery state, received signal strength, date, time etc. Such a status bar is sometimes referred to as a “decor item” or “system decoration”. Such a bar is typically part of the desktop (sometimes the desktop is visible through the status bar). In some cases it is re-rendered with each opening of a new application (e.g. a light-on-dark rendering for a dark application and vice-versa for a bright application). Sometimes the operating system causes the status bar to disappear when the device is in full-screen landscape mode. Such a status bar is provided by the window manager in the operating system. Because the status bar is provided by the window manager that controls the entire screen, the user often has control over formatting of the status bar through user-controllable settings (for example whether the status bar is at the top or bottom of the screen).

### SUMMARY OF THE INVENTION

In accordance with a first aspect of the invention, a method is provided for displaying windows on a screen of a mobile device. The method comprises; providing, from a surface manager to a first window manager, a first window of a device wherein the first window is smaller than the area of the screen; generating, by the window manager, a first display for the first window; and generating, by a dedicated content manager, a second display for a second window. The second window is a portion of the screen not used by the first window manager, and is dedicated for use by the dedicated content manager. Applications are displayed in the first window while dedicated content is displayed in the second window. The step of providing, from a surface manager to a first window manager, may be in response to a request from the first window manager.

Means may be provided for receiving the dedicated content for display in the second window. Thus, applications are launched and displayed in the first window and the received Information is displayed in the second window.

A trigger event may be detected, such as a change of orientation of the mobile device to landscape mode. The surface manager may close the second window upon detection of the trigger event. In doing so, the surface manager may make the entire screen available to the first. window manager, for use by any application that is being managed by the operating system. Another possible trigger event is a mode of operation, E.g. a gaming mode, a full screen video, or a camera mode.

In one aspect, when a touch screen is activated in the second window, the surface manager preferably instructs the window manager to ignore this. The surface manager may provide an Indication of the activation (e,g. with co-ordinates) to the dedicated content manager. As a result of an indication of the touch to the second window, the dedicated content manager may provide an instruction (e.g. a launch command and/or an address or URL) to a special information application. Content from the URL or address may be displayed in the first window.

The mobile device may have computer program layers that include an application layer, a hardware driver layer and at least one operating system, OS, layer therebetween.

The surface manager is in the OS layer, and the window manager and the dedicated content manager are in an OS layer above the window manager. The surface manager in the OS layer reserves a portion of the available screen for dedicated use and presents to higher layers a remainder portion of the screen as the entire screen available to the higher layers.

In accordance with another aspect of the invention, a device is provided having; a screen; an operating system having a surface manager for presenting a first window on the screen wherein the first window is smaller than the area of the screen; a dedicated content manager for presenting a second window wherein the second window is a portion of the screen not used by the first window manager, and wherein the second window is dedicated for use by the dedicated content manager; and a plurality of applications under the control of the operating system for presentation in the first window but not in the second window.

Other features and advantages of the invention will become apparent after review of the entire application, including the following sections: brief description of the drawings, detailed description and claims.

### BRIEF DESCRIPTION OF THE DRAWINGS

The accompanying drawings illustrate exemplary aspects of the invention, and, together with the general description given above and the detailed description given below, serve to explain features of the invention.

FIG. 1 is a block diagram illustrating the internal architecture of a device.

FIG. 2 is a block diagram illustrating exemplary components of the operating system used by the device.

FIG. 3 is a process flow diagram illustrating a flow for display of a banner window.

FIG. 4 illustrates a device with and without a banner window.

FIG. 5 is a process flow diagram illustrating interactions with a banner window.

FIG. 6 is a process flow diagram illustrating a window manager with plugins.

### DETAILED DESCRIPTION

The various aspects of the invention will be described in detail with reference to the accompanying drawings by way of example only. Wherever possible, the same reference numbers will be used throughout the drawings to refer to the same or like parts. References made to particular examples and implementations are for illustrative purposes, and are not Intended to limit the scope of the Invention or the claims.

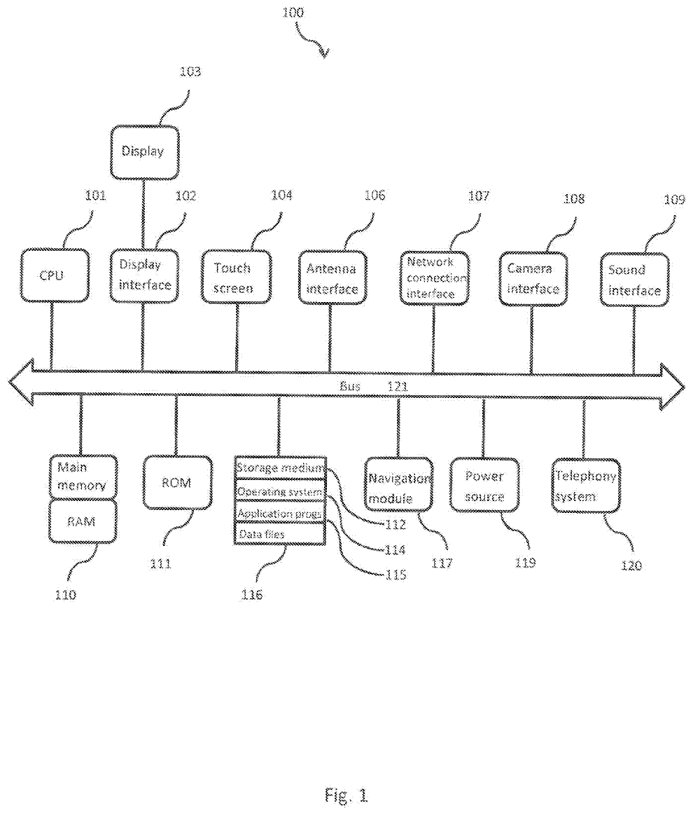

FIG. 1 is a block diagram illustrating an internal architecture 100 of a device. The architecture includes a central processing unit (CPU) 101 where the computer instructions that comprise an operating system or an application are processed; a display interface 102 that provides a communication interface and processing functions for rendering video, graphics, images, and texts on a display 103, Display interface 102, provides a set of built-in controls (such as buttons, text and lists), and supports diverse screen sizes. There Is a touch screen 204 that overlays the display 103 and provides a communication interface to the device. There is also: an antenna interface 106 that provides a communication interface to an antenna; a network connection interface 107 that provides a communication interface to a network over a computer network connection; a camera interface 108 that provides a communication interface and processing functions for capturing digital images from a camera; a sound interface 109 that provides a communication interface for converting sound Into electrical signals using a microphone and for converting electrical signals into sound using a speaker; a random access memory (RAM) 110 where computer Instructions and data are stored in a volatile memory device for processing by the CPU 101; a read-only memory (ROM) 111 where invariant low-level systems code or data for basic system functions such as basic input and output (I/O), startup; and a storage medium 112 or other suitable type of fixed or removable memory (e.g. RAM, ROM, PROM, EPROM), where files are stored. The files include an operating system 114, application programs 115 (including, for example, a web browser application, a widget or gadget engine, and or other applications, as necessary) and data files 116. Also shown are: a navigation module 117 that provides a real-world or relative position or geographic location of the device; a power source 119 that provides an appropriate alternating current (AC) or direct current (DC) to power components; and a telephony subsystem 120 that allows the device to transmit and receive sound over a telephone network. The constituent devices and the CPU 101 communicate with each other over a bus 121.

A computer program product is tangibly embodied in storage medium 112, a machine-readable storage medium. The computer program product includes instructions that, when read by a machine, operate to cause a data processing apparatus to store image data in the mobile device. In some embodiments, the computer program product Includes instructions that generate notifications about alerts such as newly arriving messages on the device.

The operating system 114 is modified from an ANDROID (trademark) and/or L1NUX-based operating system such as a mobile device platform; APPLE MAC OS X; MICROSOFT WINDOWS NT/WINDOWS 2000/WINDOWS XP/WINDOWS MOBILE (trademarks); a variety of UNIX-flavored operating systems; or a proprietary operating system for computers or embedded systems. The application development platform or framework for the operating system 114 may be: BINARY RUNTIME ENVIRONMENT FOR WIRELESS (BREW); JAVA Platform, Micro Edition (JAVA ME) or JAVA 2 Platform, Micro Edition (J2ME) using the SUN MICROSYSTEMS JAVASCRIPT programming language; PYTHON FLASH LITE, or MICROSOFT .NET Compact (trademarks), or another appropriate environment.

The device stores computer-executable code for the operating system 114, and the application programs 115 such as an email, instant messaging, a video service application, a mapping application word processing, spreadsheet, presentation, gaming, mapping, web browsing, JAVASCRIPT engine, brother applications. For example, one implementation may allow a user to access an email application, an instant messaging application, a video service application, a mapping application, or an image editing and presentation application. The application programs 115 may also Include a widget or gadget engine, such as the WINDOWS SIDEBAR gadget engine or a YAHOO! widget engine such as the KONFABULTOR widget engine (trademarks), or other widget or gadget engine the provides host system software for a physically-inspired applet on a desktop.

Although It is possible to provide for notifications and interactions with messages and other events using the above-described implementation, it is also possible to implement the functions, for example as described in U.S. Pat. No. 9,152,309 81, as a dynamic link library (DLL), or as a plug-in to other application programs such as an internet web-browser such as the FIREOX web browser, the APPLE SAFARI web browser or the MICROSOFT INTERNET EXPLORER: web browser (trademarks).

The navigation module 117 may determine an absolute or relative position of the device, such as by using the Global Positioning System (GPS) signals. The navigation module 117 may also be used to measure angular displacement, orientation., or velocity of the device, such as by using one or more accelerometers.

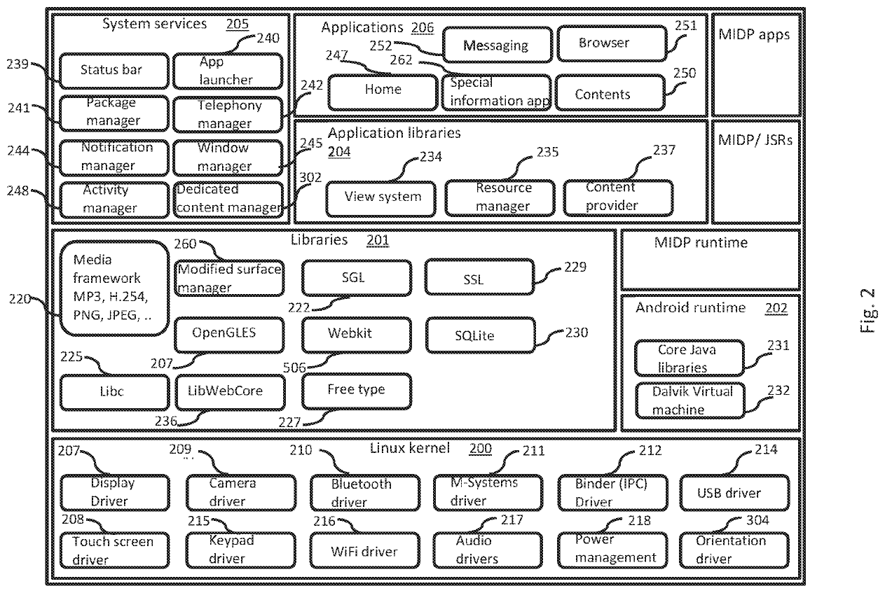

FIG. 2 is a block diagram illustrating exemplary components of the operating system 114 used by the device, in the case where the operating system 114 is a mobile device platform. The operating system 114 invokes multiple processes, while ensuring that the associated phone application is responsive, and that wayward applications do not cause a fault (or “crash”) of the operating system. Using task switching, the operating system 114 allows for the switching of applications white on a telephone call, without losing the state of each associated application. The operating system 114 may use an application framework to encourage reuse of components, and provide a scalable user experience by combining pointing device and keyboard inputs and by allowing for pivoting. Thus, the operating system cab provide a rich graphics system and media experience, while using an advanced, starsdards-based wed browser.

The operating system 114 can generally be organized into six components: a kernel 200, libraries 201, an operating system runtime 202, application libraries 204, system services 205, and applications 206. The kernel 200 includes a display driver 207 that allows software such as the operating system 214 and the application programs 215 to interact with the display 201 via the display interface 202; a touch screen driver 208 that allows the software to interact with the touch screen 104; an orientation driver 304 which allows monitoring of the orientation of the device; a camera driver 209 that allows the software to interact with the camera; a BLUETOOTH (trademark)_driver 210; a M-Sysfems driver 211; a binder (IPC) driver 212, a USB driver 214 a keypad driver 215 that allows the software to interact with the keyboard via the keyboard interface 104; a WiFi driver 216; audio drivers 217 that allow the software to interact with the microphone 209 and the speaker via the sound interface 109; and a power management component 219 that allows the software to interact with and manage the power source 219.

The libraries 201 include a media framework 220 that supports standard video, audio and still-frame formats (such as Moving Picture Experts Group (MPEG)-4 and others) using an efficient JAVA (trademark) Application Programming interface (API) layer; a simple graphics library (5GL) 222 for two-dimensional application drawing; an Open Graphics Library for Embedded Systems (OpenGL ES) 224 for gaming and three-dimensional rendering; a C standard library (LIBC) 225; a U LIBWEBCOE library 226; a FreeType library 227; an SSL 229; an SQLite library 230; a webkit 506; and a modified surface manager 260 which is modified vis-à-vis known surface managers such as that described in U.S. Pat. No. 9,152,309 81.

The operating system runtime 202 includes core JAVA libraries 231, and a Dalvik virtual machine 232. The Dalvik virtual machine 232 is a custom, virtual machine that runs a customized file format (.DEX).

The operating system 114 can also include Mobile information Device Profile (MIDP) components such as the MIDP JAVA Specification Requests (JSRs) components, MIDP runtime, and MIDP applications as shown in FIG. 2. The MIDP components can support MIDP applications running on the device.

With regard to graphics rendering, a system-wide composer manages surfaces and a frame buffer and handles window transitions, using the OpenGL ES 224 and two-dimensional hardware accelerators for its compositions.

The application libraries 204 Include a view system 234, a resource manager 235, and content providers 237. The system services 205 includes a status bar 239; an application launcher 240; a package manager 241 that maintains Information for all installed applications; a telephony manager 242 that provides an application level JAVA interface to the telephony subsystem 120; a notification manager 244 that allows all applications access to the status bar and on-screen notifications; a window manager 245 that allows multiple applications with multiple windows to share the display; and an activity manager 246 that runs each application in a separate process, manages an application life cycle, and maintains a cross-application history.

The applications 206 include a home application 247, a contacts application 250, and a browser application 251.

The telephony manager 242 provides event notifications (such as phone state, network state, Subscriber identity Module (SIM) status, or voicemail status), allows access to state information (such as network Information, SIM information, or voicemail presence), initiates calls, and queries and controls the call state. The browser application 251 renders web pages in a full, desktop-like manager, including navigation functions. Furthermore, the browser application 251 allows single column, small screen rendering, and provides for the embedding of HTML views into other applications.

The modified system 114 includes modifications from a known operating system as will become apparent. A novel dedicated content manager 302 is added in the system services layer 205. Special information application 262 may, optionally, be provided as one of applications 206.

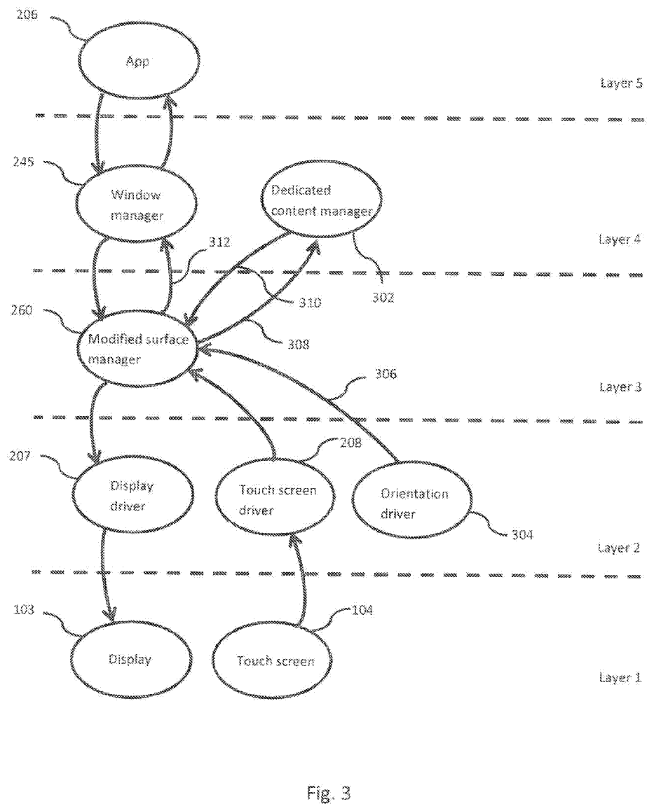

Aspects of the invention will be described with reference to FIG. 3 FIG. 3 shows an example stack of an operating system having five layers from layer 1 (lowest) to layer 5 (highest). Layer I represents the hardware and comprises the display 103 with Its display interface 102 and the touch screen 104 of FIG. 1. Layer 1 may also comprise a RF module, power source 119, main memory and RAM 110, ROM 111, CPU 101, bus 121, a camera, one or more audio speakers and so forth.

Layer 2 comprises drivers for hardware in layer 1. for example orientation driver 304, display driver 207 related to the display 103 and touch screen driver 208 related to touch screen 104.

Layer 3 comprises libraries 201 including modified surface manager 260.

Layer 4 comprises system services 205 including window manager 245 which may be as described with reference to FIG. 2.

Additionally. Layer 4 has a novel dedicated content manager 302. The dedicated content manager 302 is a service which receives and provides content to display, and may be interacted with by the user of the device. Because dedicated content manager 302 is a service item In the layer 4 of the operating system, it has more privileges than an application in layer S and cannot be installed, modified, or uninstalled by the user.

Layers 3 and 4 represent the OS that protects the device against loading of applications by the user that may exploit vulnerabilities if not controlled by the OS at these layers. Where a new vulnerability is identified in the OS itself, the OS can be upgraded (by patch or otherwise). When the OS is upgraded, the described modification to the surface manager is maintained.

Layer 5 comprises applications 206 described with reference to FIG. 2 and, optionally, special information application 262. An application is a module of software that is user Installable and uninstallable. it runs at a level that is less privileged than the OS—i.e. all applications are subject to constraints by the OS, for example security constraints, constraining their access to other software modules and other functions of the device. These constraints are necessary for security and other reasons.

interactions between the various processes shown take the form of a request and response.

In operation, the display driver 207 reads a file containing hardware parameters to ascertain the site of the display 103. These are queried using the queries: getSize(Point), getRectSize(Rect) and getMetrics(DisplayMetrics). The display driver 207 provides this information to the modified surface manager 260.

The modified surface manager 260 defines “Display”, which is a java object that provides information about the size and density of a logical display. The display area is described in two different ways. The application display area specifies the part of the display that may contain an application window, excluding the system decorations. The application display area may be smaller than the real display area because the modified surface manager 260 subtracts the space needed for decor elements such as the status bar. The real display area specifies the part of the display that contains content including the system decorations.

The display area that is presented by the window manager 245 to higher layers in the operating system is referred to as the “real” display. It is the part of the area of the screen drawn by the window manager 245 that also defines the desktop. In use, a user launches an application 206 (e.g. a messaging application 252 or a map application or a browser 251), and this is presented in the “real” display. Thereafter, the application 206 communicates with the display 103 and the touch screen 104 in the usual manner through the software layers and through the window manager 245, modified surface manager 260, display driver 207, and touch screen driver 208.

In an example implementation of aspects of the present Invention, a reduced screen size is presented to the higher layers of the operating system . On a request-response basis, the first Window manager asks the surface manager the size of the Window, and the latter responds with the smaller area. In this way, a reserved screen area is set aside that Is available for other (e.g. dedicated) purposes that will be described.

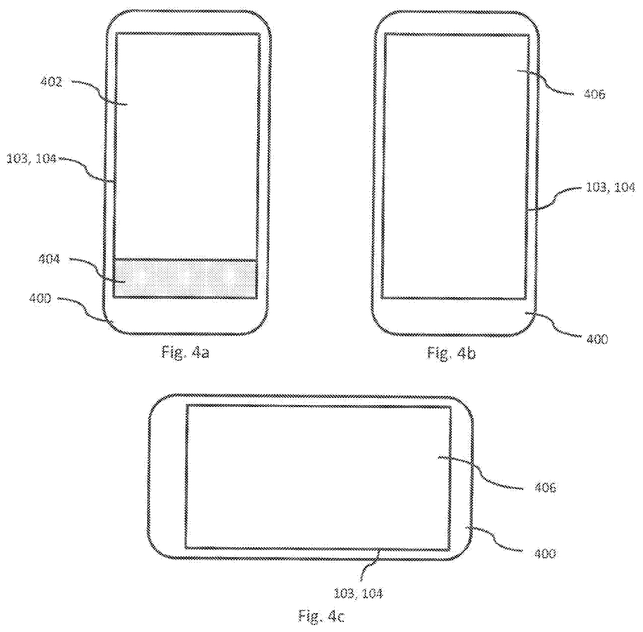

In particular, the modified surface manager 260 re-defines the primary screen area to have a slightly Smaller height (at least when In portrait orientation). This is shown In FIG. 4,

With reference to FIG. 4a, the total area 406 of the display 103 of a device 400 is split into a primary portion 402 and a secondary portion 404. The secondary portion extends across the full width of the display and is preferably 50 pixels in height. Thus the secondary portion 404 preferably takes the form of a banner. 50 pixels is a convenient height, because it equates to an internet Advertising Bureau (IAB) banner height.

An IAB banner is typically 320×50 pixels, Thus, content may be received from a server (not shown) that is set according to the IAB banner standard size. if the secondary portion 404 is less than or greater than 320 pixels in width, the content may be scaled so that it matches the secondary portion, or padded so that it fills that portion (or partly scaled and partly: padded).

The secondary portion 404 preferably occupies between about 6% and 15% of the height of the display when in portrait orientation. Thus, the aspect ratio of the primary portion is reduced by only a small amount. E.g. a display having dimensions 14 cm tall×7 cm wide may be reduced by about 0.8 cm to 1.5 cm. The aspect ratio may be reduced by about 8% to about 12%.

An alternative mechanism for making the “real” display size less that the physical display size is though use of <adb shell wm size>, which is a parameter that is provided in Android Developers Toolkit to allow the window manager to emulate a smaller display for purposes of testing applications on displays of different sizes.

The window manager 245 manages the primary portion 402 of the display 103 and touch screen 104. The dedicated content manager 302 is dedicated to managing the secondary portion 404 of display 103 and the touch screen 104. The window manager 245 is only aware of the primary portion 402 of the touch screen 104. It is “spoofed” into an understanding that the display Is smaller than it actually is. Content related to application 206 is displayed in the primary portion 402 by any of the manners known in the art. Thus, applications can be installed and upgraded and the operating system can he upgraded, provided that the upgraded operating system includes the described modified surface manager 260. Any number of standard applications can be installed and run without regard to or knowledge of the spoofing by the modified surface manager 260 to the higher layers that the screen size available to them has been reduced.

Spoofing or deceiving the window manager 245 by providing modified surface manager 260 means that the splitting of the screen into the primary and secondary portions occurs at the lowest possible layer. This means that the window manager 245 and applications 206 require no modification. They can continue as if they are using the total screen area 406, and can be updated in the normal manner. The modified surface manager 260 provides, in response to requests from the window manager 245, a primary portion or first window of the device to the window manager 245 in the normal manner.

The content displayed in the secondary portion 404 of the display 103 is preferably provided by the dedicated content manager 302, and the modified surface manager 260 via arrow 310. Content provided by the dedicated content manager 302 may, for example, be continually updated or may have been downloaded and saved in the device memory 110 at some time in the past (e.g. as described in international Patent Application WO 2016/063005 A1).

The content provided by the dedicated content manager 302 may be obtained in a number of ways, It may be pre-installed but is preferably received by wireless (or other) means, e.g. on a real-time or regular or periodic basis. For example, if the content comprises news, weather or advertising content, the content is received from a server, such as an advertisement exchange (not shown) or an advertising network (not shown). The content is blended by means of a user profile to select advertisements targeted to the user.

Another example of content is content that is synthesized in the device 400 based upon inputs to the device. An example is the user's biometric data. This may be continuously measured and processed by the dedicated content manager 302. It may be displayed in the secondary portion 404 (e.g. as a continuous heart rate display) or secondary portion 404 may be caused to open only when the received inputs trigger an event, for example cause a threshold (set by dedicated content manager 302) to be crossed. An example is a biometric threshold such as pulse rate (lower or upper threshold), blood sugar level, blood pressure etc.

In the case where the secondary portion is caused to open based on an event, the dedicated content manager 302 instructs the modified surface manager 260 to open the secondary portion 404. In effect, the modified surface manager responds to this instruction by re-defining, to higher layers of the OS, the site of the real display.

In the case of advertising content, the dedicated content manager 302 manages the content appearing in the secondary portion 404, and is a client for the advertisement exchange or advertisement network which prepares content for display. Alternatively or additionally, the content might be stock and share prices, in which case the dedicated content manager 302 act as a client to receive updates from a server.

Referring now to FIG. 4, display of the secondary portion 404 is preferably dependent upon mode and/or orientation of the device.

The orientation of the device is monitored by orientation driver 304 and reported to modified surface manager 260 via arrow 306. Modified surface manager 260 uses this information to determine whether to display the secondary portion 404. Orientation driver 304 may he part of navigation module 117.

in FIG. 4a, secondary portion 404 is shown as a banner. Secondary portion 404 is shown at the bottom of touch screen 104 and display 103, however it will be understood that the secondary portion 404 may he provided at a different area of the touch screen 104 and display 103, for example at the top or along one side.

FIGS. 4b and 4c show device 400 displaying the primary portion over the total area 406 of the display 103.

As Indicated in FIG. 4b, the modified surface manager 260 allows the window manager 245 to display in the total area 406 if the device is in portrait orientation and is in camera mode. The mode or modes that permit this format of display to be activated are pre-programmed in the modified surface manager 260. Examples are: camera mode, gaming mode and video mode. These are modes for which a prior determination has been made that users Will generally prefer to have the full screen available.

In another example shown in FIG. 4c, the total area 406 of the display 103 is used in response to the device being used in landscape mode. As described with reference to FIG. 3, moving to landscape orientation causes the orientation driver 304 to provide information via arrow 306 to modified surface manager 260. Modified surface manager 260 informs window manager 245 to display in the total area 406 via arrow 312. Thereafter, the application 206 is allowed to display in the total area 406 of touch screen 104 end display 103.

In landscape orientation, the device may be displaying a video: or a gaming application, or the device camera may be in use.

In summary, the decision by the modified surface manager 260 to suppress the secondary window and to present the whole display to higher layers may be based on orientation or mode or a combination of the two (e.g. based on landscape orientation OR certain pre-defined mode). “Mode” is independent of application, For example a Facebook (trademark) application may Invoke camera mode.

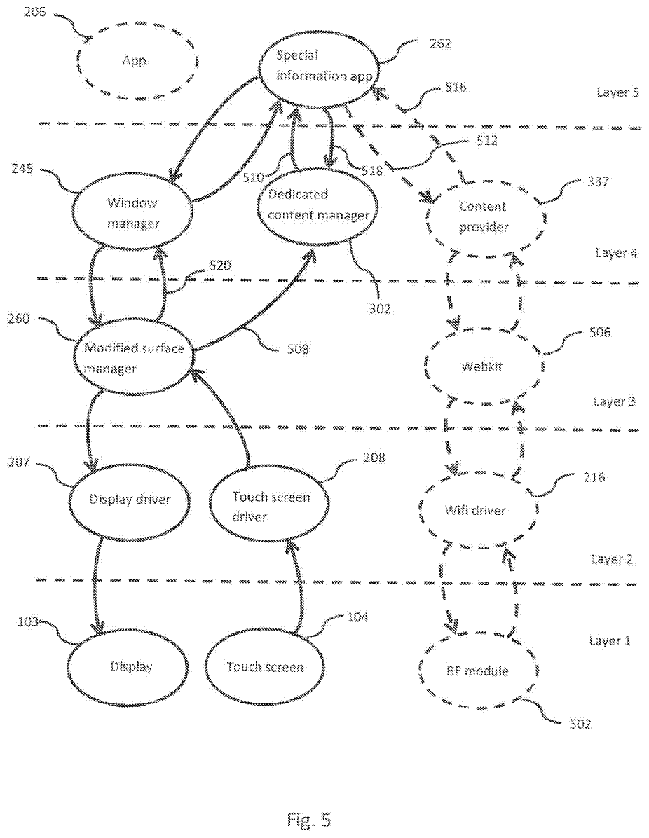

Referring now to FIG. 5, the description of operation will continue With the touching by the user of the secondary portion 404 of the total area 406 of the touch screen 104. Information related to the touch may be passed through the layers of the stack via the touch screen driver 208 and to the modified surface manager 260. The modified surface manager 260 Is cognisant that the total area 406 is split into primary portion 402 and secondary portion 404. Modified surface manager 260 is able to recognise in which portion of the screen 104 the touch was located. If the modified surface manager 260 determines that the touch was located in the primary portion 402 then it passes the information (i.e. the location of the touch) to window manager 245, represented by arrow 520. Window manager 245 passes the information to application 206. The information flows to window manager 245 and then to application 206 may proceed in a manner already described,

Alternatively, modified surface manager 260 may determine that the touch was made in the secondary portion 404 of the touch screen 104, In this case, the modified surface manager 260 directs the information along arrow 508 to the dedicated content manager 302. Because the Window manager 245 is “spoofed” into believing that the display is smaller than it actually is, the touch on the secondary portion 404 is outside this area. It may be necessary, nevertheless, that the window manager 245 is informed that it should Ignore the touch on the touch screen. This command to ignore the touch is represented by arrow 520 from the modified surface manager 260.

The area touched on may include a link to a webpage or similar and the dedicated content manager 302 identifies this and identifies the URL or address of the link.

The dedicated content manager 302 sends a message via arrow 510 causing special information application 262 to be launched for display in the primary portion 402 of the display. The special Information application 262 instantiates a browser in the application. The browser function is provided by webkit service 506 in layer 3 of the OS. Alternatively, special information application 262 may be a web browser, a reduced web browser or similar. Information represented by arrow 510 may also include the URL or address. This allows the special information application 262 to fetch and display the content at the URL or address.

Special information application 262 is launched and is provided on the screen In place of application 206.

An example of special information application 262 is an advertising and redemption application that allows a user to respond to an advertisement in the secondary portion 404 by providing more extensive information relating to a displayed advertisement and allowing a user to interact with the server that delivered the advertisement, e.g. to purchase goods or services or to redeem coupons previously presented in the secondary portion 404.

Arrow 512 represents special information application 262 requesting the information at the URL or address from a content provider 337. The request may be passed through the layers of the stack to the webkit 506, the WiFi driver 216 and the RF module 502 or along another such path depending on the content of the address or URL and nature of the content to be fetched for display. Information is subsequently received and passed up the stack to the content provider 337 and special information application 262 via arrow 516.

Special information application: 262 passes the information through the stack for rendering via the window manager 245, modified surface manager 260, display driver 207, and finally to the display 103 for display to the user in the primary portion 402 of the display 103, in the manner previously described in relation to FIGS. 3 and 4. The user thereafter interacts with special information application 262 via touch screen 104 in the primary portion 402 of the display in the normal manner.

As the special information application 262 is an application, it may be installed end uninstalled by the user of the device. If, when a user clicks on the secondary portion 404 of the screen, the special information application 262 is not installed, then arrow 510 leads the user to a prompt requesting him or her to download and install special Information application 262.

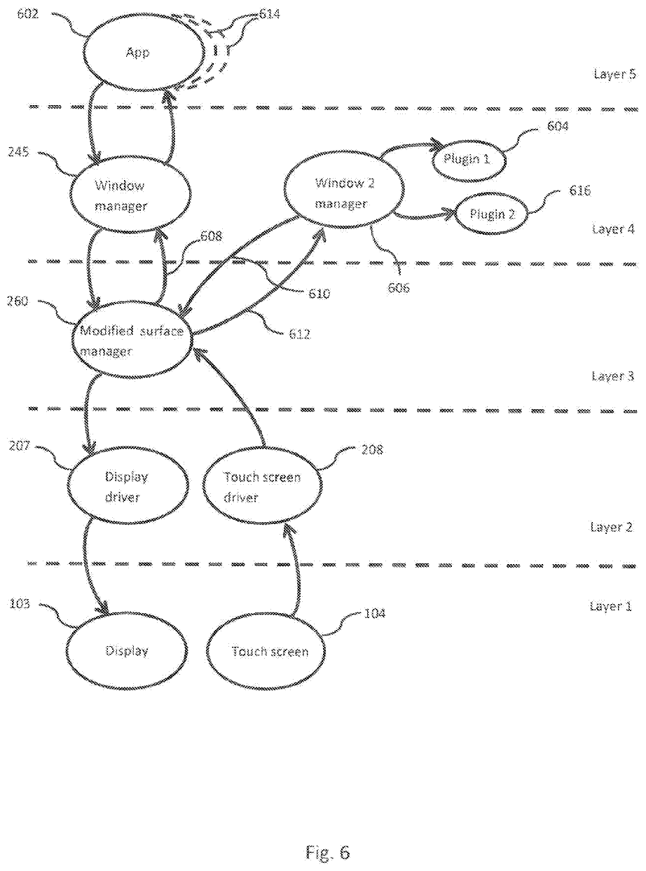

Referring now to FIG. 6, the dedicated content manager 302 is replaced by window 2 manager 606. The window 2 manager 606 is substantially similar to the dedicated content manager 302 described previously, but is associated with one or more plugins 604, 616. The piugins 604, 606 may also be referred to as applets, however because they reside in layer 4 they are riot applications and they cannot be Installed, modified, or deleted by the user of the device.

The window 2 manager 606 manages content for display in the secondary portion 404 and responds to touches in the secondary portion 404 of the display 103 and touch screen 104 In much the same manner as previously described for the dedicated content manager 302. The window manager 245 manages the primary portion 402 of the display 103 and touch screen 104 as previously described. The primary portion 402 is used to display applications 602, 614.

The plugins 604, 616 display individually, simultaneously, or on a scrolling loop in the secondary portion 404 of the display 103 arid touch screen 104. The plugins 604, 616 are dedicated for use only in the secondary portion 404. The user may interact with the plugins 604, 616 in the secondary portion 404, clicking on links, opening windows and the like within the secondary portion 404.

The plugins 604, 616 have similar content to that described with regard to the dedicated content manager 302. The plugins 604, 616 display received information including, for example, advertisements, news, weather, or the user's biometric data and is blended by means of a user profile to target information to the user. Content shown by the plugins 604, 616 may be continually updated or may have been downloaded and saved in the device memory 110 at some time In the past (e.g. as described in International Patent Application WD 2016/063005 A1).

It will be understood that further dedicated content managers or window 2 managers can be provided to manage a tertiary portion of display 103 and touch screen 104, a quarternary portion and so forth. The portions may be arranged as banners along edges of the screen, as banners elsewhere on the screen, or the screen area may be divided equally or otherwise between the two or more screen portions.

A method has been described of presenting a split screen on a mobile device having a screen and having computer program layers that include an application layer, a hardware driver layer and at least one operating system. OS, layer therebetween, the method comprises: in a surface manager in the OS layer, reserving a portion of the available screen for dedicated use and presenting to higher layers a remainder portion of the screen as the entire screen available to higher layers; providing a dedicated service software module in the OS layer that has received information for display; displaying the received information in the reserved portion of the display, whereby applications are launched and displayed in the remainder portion of the display and the received information is displayed in the reserved portion. The received information may be displayed only in the reserved portion, and only the received information is displayed in the reserved portion.

Also described is a method of presenting received information in a dedicated portion of a screen of a mobile device that has an operating system, the method comprising; providing a surface manager module in the operating system, wherein the surface manager has information defining the total size of the screen; in the surface manager, reducing the screen dimensions so as to create a reduced screen area and a reserved area; operating applications above the operating system level using the reduced screen area; operating a received information service using the reserved area. The method may include identifying, in a driver layer of the mobile device software below the surface manager, the total size of the screen and reporting this to the surface manager.

A method is further described of presenting a split screen on a mobile device having a screen and having computer program layers that include an application layer, a hardware driver layer and at least one operating system, OS, layer therebetween, the method comprising: identifying, in the driver layer, the size of the screen and reporting this to the at feast one OS layer; splitting the screen in the OS layer into a first part and a second part; rendering applications in the application layer using the first part; rendering services from a dedicated service in the OS using the second part.

1. A method for displaying windows on a screen of a mobile device comprising: providing, from a surface manager to a first window manager, a first window of a device wherein the first window is smaller than the area of the screen:
generating, by the window manager, a first display for the first window:
generating, by a dedicated content manager, a second display for a second window:
wherein the second window is a portion of the screen not used by the first window manager, and wherein the second window is dedicated for use by the dedicated content manager: displaying, the first display in a first window arid the second display in the second window.

2. The method of claim 1, further comprising:
reserving, by the surface manager, a portion of the available screen for dedicated use by the dedicated content manager, and presenting a remainder portion of the screen as the entire screen available to the window manager.

3. The method of any preceding claim, further comprising:
receiving information for display in the second window, and
displaying the received information In the second window,
whereby applications are launched and displayed in the first window and the received information is displayed in the second window.

4. The method of and preceding claim, further comprising:
detecting a trigger event
dosing, by the surface manager, the second window upon detection of the trigger event.

5. The method of claim 4, wherein the trigger event comprises a change of orientation of the mobile device to landscape mode.

6. The method of claim 4 or 5, wherein the trigger event comprises a gaming mode, a full screen video, or a camera mode.

7. The method of any preceding claim, further comprising:
providing, from the surface manager to the window manager, an indication to ignore a touch to the second window.

8. The method of any preceding claim, further comprising:
providing, from the surface manager to the dedicated content manager, an indication of a touch to the second window.

9. The method of claim 8, further comprising:
providing, from the dedicated content manager to a special Information application, a URL or address as a result of the indication of the touch to the second window.

10. The method of claim 9, further comprising displaying on the first window content from the URL or address.

11. The method of any preceding claim, wherein
the mobile device having computer program layers that include an application layer, a hardware driver layer and at least one operating system, OS, layer therebetween; wherein the surface manager is in the OS layer, and the window manager and the dedicated content manager are in a higher OS layer, and
wherein the surface manager in the OS layer, reserves a portion of the available screen for dedicated use and presents to higher layers a remainder portion of the screen as the entire screen available to higher layers.

12. A device having
a screen;
an operating system having a surface manager for presenting a first window on the screen wherein the first window is smaller than the area of the screen;
a dedicated content manager for presenting a second window wherein the second window is a portion of the screen not used by the first window manager, and wherein the second window is dedicated for use by the dedicated content manager; and
a plurality of applications under the control of the operating system for presentation in the first window hut not in the second window.

13. A computer program product comprising instructions which, when executed by a computer, cause the computer to carry out the steps of the method of claim 1.
